(19) United States
(12) Patent Application Publication
(10) Pub. No.: US 2008/0316372 A1
(43) Pub. Date: Dec. 25, 2008

(54) VIDEO DISPLAY ENHANCEMENT BASED ON VIEWER CHARACTERISTICS

(76) Inventors: Ning Xu, Irvine, CA (US); Yeong-Taeg Kim, Irvine, CA (US)

Correspondence Address: KNOBBE, MARTENS, OLSON, & BEAR, LLP, 2040 MAIN STREET, FOURTEENTH FLOOR, IRVINE, CA, 92614, US

(21) Appl. No.: 11/765,974

(22) Filed: Jun. 20, 2007

(51) Int. Cl. H04N 5/66

(52) U.S. Cl. 348/739; 348/E05.133

(57) ABSTRACT

A video display with a display screen adapted to display video images according to adjustable display parameters, for example brightness, contrast, and/or sharpness, and at least one viewer sensor configured to determine at least one variable viewing characteristic and wherein the display is adapted to adjust the display parameters to adjust the displayed video image quality at least partially as a function of the variable viewing characteristic. A method of adjusting displayed image quality of a video display system, including inducing the video display system to determine at least one characteristic of a current viewing situation and adjusting one or more variable display parameters at least partially as a function of the determined characteristics. The viewing characteristics can include viewing time, viewing distance, and other.

### BACKGROUND OF THE INVENTION

1. Field of the Invention

The invention relates to the field of video displays and to systems and methods of automatically adjusting display parameters based, at least partially, on one or more characteristics of the viewer(s).

2. Description of the Related Art

Video monitors are widely employed to display still and/or moving video images in a wide variety of products such as televisions, computer monitors, vehicle mounted information, and/or entertainment units, and the like. Video monitors are generally adapted to receive an incoming analog or digital video signal, and to process the incoming video signal for display on a display screen that can comprise display types such as cathode ray tubes (CRTs), plasma displays, liquid crystal displays (LCDs), organic light emitting displays (OLEDs), etc. Display screens are frequently capable of processing the incoming video signals and displaying the video image(s) according to adjustable or variable display parameters. For example, display parameters such as brightness, contrast, sharpness, and/or color balance are frequently adjustable such that a user can adjust the display parameters to achieve a video image that is displayed according to their particular preferences.

Accordingly, video displays are frequently provided with adjustment controls generally either via controls arranged directly on the video display or via an interface to a remote control unit. However, existing display adjustment systems have limited effectiveness in optimizing the display parameters for a giving viewing situation. For example, existing display adjustment systems typically require the user to actuate user controls in concert with an adjustment menu displayed on the video display. Such systems typically require the user to step through a particular control sequence to arrive at the appropriate display adjustment menu and provide the appropriate adjustment control inputs. This is a relatively inconvenient and complicated procedure and at least certain users will be unable or unwilling to perform the required tasks to fine tune or optimize the display parameters for an improved display of the images.

In addition, at least certain implementations of displays with a fixed given display parameter setting can result in changes in the perceived video quality depending on length of viewing. For example, a viewer's perception of image quality can change from initial onset of viewing and for an extended period of viewing. It will thus be understood that there exists a need for improved systems and methods for adjusting a video display to provide improved display characteristics for given viewing situations. There is a further need for systems and methods of adjusting video display parameters that is more convenient for the user, for example, by requiring reduced active user involvement while still providing improved video display characteristics.

### SUMMARY OF CERTAIN INVENTIVE ASPECTS

The systems and methods of the embodiments of the present disclosure each have several aspects, no single one of which is solely responsible for its desirable attributes. Without limiting the scope of this disclosure as expressed by the claims which follow, its more prominent features will now be discussed briefly. After considering this discussion, and particularly after reading the section entitled “Detailed Description of Certain Inventive Embodiments” one will understand how the sample features of this disclosure provide advantages that include automatic self-adjustment of a video display system to reduce the burden on the user to actuate video adjustment controls. Certain embodiments include obtaining one or more signals indicative of characteristics of a viewer's viewing of a video display. Certain embodiments include automatically adjusting variable display parameters based at least partially on a viewer's viewing characteristics to adjust variable display parameters for improved perceived quality of displayed video data.

### BRIEF DESCRIPTION OF THE DRAWINGS

FIG. 1 illustrates one embodiment of a video display system having automatic display parameter adjustment capabilities.

FIG. 2 is a flow chart of one embodiment of a system and method for automatically adjusting display parameters in a video display system.

FIG. 3 is a flow chart of one embodiment of a system and method of identifying a face in a video image.

FIG. 4 is a block diagram of one embodiment of a system and method for determining video display adjustments.

FIG. 5 is a block diagram of one embodiment of a system and method for computing video display parameter adjustments at least partially as a function of viewing distance.

FIG. 6 is a block diagram of one embodiment of a system and method for adjusting sharpness of a video display system.

FIG. 7 is a flow chart of one embodiment of a system and method for automatically adjusting video display parameters at least partially as a function of viewing time.

FIG. 8 is a flow chart of one embodiment of a system and method for determining viewing time based on an analysis of an obtained video image of the viewing area.

FIG. 9 illustrates one embodiment of a system and method for adjusting contrast of a video display as a function of viewing time.

FIG. 10 illustrates a further embodiment of a system and method for adjusting contrast of a video display for improved display quality as a function of viewing time.

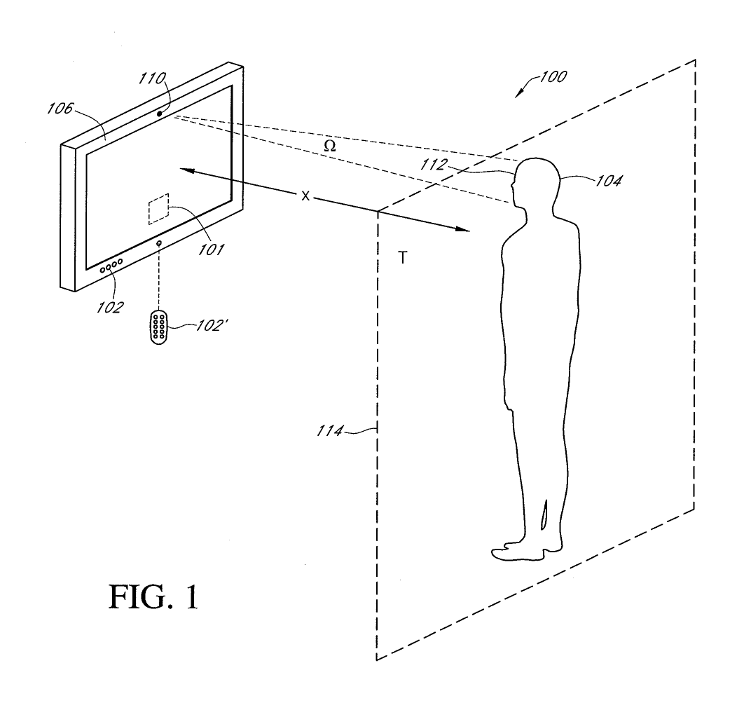

### DETAILED DESCRIPTION OF CERTAIN INVENTIVE EMBODIMENTS

Reference will now be made to various embodiments of a video display system 100. The video display system 100 is adapted to display still and/or moving video images for viewing by one or more users. In at least certain embodiments, the video display system 100 is adapted to display video images in combination with audio so as to comprise an audio/visual presentation system. In certain embodiments, the video display system 100 is configured to display audio/visual content as part of a television system. For example, the video display system 100 can be adapted to present broadcast, cable, and/or satellite television programming, recorded audio/visual programming, and/or content from one or more gaming consoles. In other embodiments, the video display system 100 is adapted to present still and/or moving video images as part of a computer system, such as a laptop and/or desktop personal computer. In yet other embodiments, the video display system 100 can comprise a portion of a personal digital assistant and/or media capable cellular telephone handset.

The video display system 100 is also adapted to adjust or vary one or more video display parameters for an improved viewing experience by one or more users/viewers of the video display system 100. In various embodiments, the adjustable or variable video display parameters can include one or more of contrast, brightness, sharpness, color level, or the like. In certain embodiments, the video display system 100 is adapted such that a user can adjust one or more of the variable video display parameters via manual adjustment, such as via user input controls 102 arranged on the video display system 100 and/or via a separate user remote control 102′ in communication with the video display system 100. The user controls 102, 102′ allow a user 104 to adjust parameters with which a video display screen 106 presents the still or moving video images presented by the video display system 100. The video display screen 106 can comprise any of a variety of known display technologies including but not limited to cathode ray tubes (CRTs), liquid crystal displays (LCDs), organic light emitting displays (OLEDs), and/or plasma displays.

The video display system 100 also comprises one or more sensors 110 adapted to determine one or more characteristics of the viewing situation in which the video display system 100 is employed. By obtaining measurements indicative of the particular viewing situation in which the video display system 100 is being employed in, adjustment of video display parameters of the video display system 100 is facilitated. For example, in certain embodiments, adjustment of video display parameters such as contrast and/or sharpness can be adjusted based on one or more characteristics of the user 104 in relation to the video display system 100. In certain embodiments, adjustment of one or more video display parameters can be performed by the video display system 100 itself thereby reducing inconvenience and burden on the user 104 to obtain a more desirable image quality as presented by the display screen 106.

In one embodiment, the viewer characteristic sensor 110 is adapted to determine a distance X between the viewer 104 and the video display screen 106. The relative viewing distance X between the user 104 and the video display screen 106 affects preferred settings of at least certain variable video display parameters for an improved viewing experience by the user 104.

In one embodiment, the viewer characteristic sensor 110 comprises a camera. In this embodiment, the sensor 110 is adapted to obtain an image of a viewing scene 114 which can include the user 104. The sensor 110 is adapted to obtain an image of the viewing scene 114 which can then be analyzed to determine characteristics of the viewing scene 114 and determine an indication of the viewing distance X. In one embodiment, the sensor 110 is adapted to image the viewing scene 114 to allow a face portion 112 of the user 104 to be identified. The face portion 112 will subtend a solid angle Ω. The value of the solid angle Ω is indicative of the viewing distance X between the user 104 and the video display screen 106. Thus, the apparent size of the face region 112 can be utilized to infer the viewing distance X and thereby adjust one or more video display parameters for an improved image quality as perceived by the user 104 at the viewing distance X. As previously noted, in certain embodiments, the video display system 100 is adapted to perform at least certain adjustments of the variable video display parameters automatically, thereby, facilitating adjustments of the video display parameters in an automated fashion providing increased convenience and perceived quality from the video display system 100 to the user 104.

The operation of the system 100 is controlled, at least in part, by one or more control systems 101. The control system 101 is adapted to receive signals from the sensor(s) 110 and to evaluate the signals for determination of one or viewer characteristics as described in greater detail below. The control system 101 is also adapted to provide control signals to induce adjustment of one or more variable display parameters under which the video display screen 106 displays video data. In various embodiments, the control system 101 can be embodied as a set of operating instructions that can be stored on recordable storage media or conveyed via wired or wireless communication links. The control system 101 can also be embodied as electronic circuits adapted to provide the functionality described herein. For example, in certain embodiments, the control system 101 comprises a processor based control circuit. In certain embodiments, the control system 101 is preferably embodied as part of the system 100.

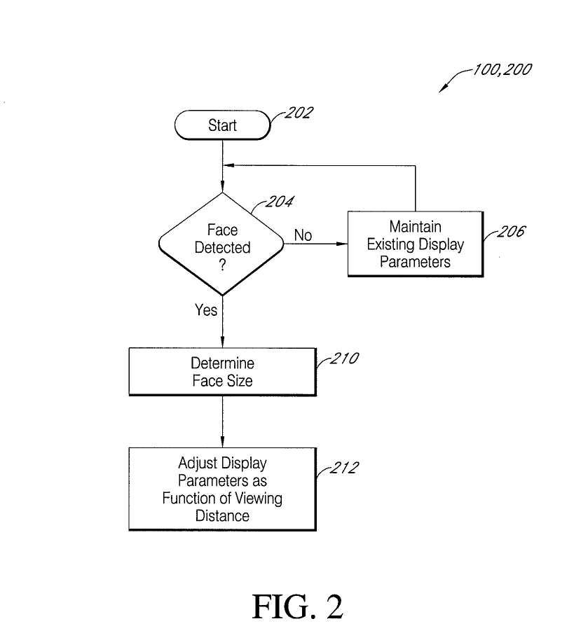

FIG. 2 is a flow chart of one embodiment of a method 200 that the video display system 100 can employ to improved perceived video display quality as presented by the display screen 106. In certain embodiments, the method 200 is implemented at least in part, by one or more processors of the display system 100. In this embodiment, the method 200 begins in a start block 202 and proceeds to a decision block 204 wherein a determination is made whether or not a face corresponding to a viewer 104 is detected. If the result of decision block 204 is negative, the method 200 proceeds to a block 206 wherein the preexisting settings of the variable video display parameters are maintained. For example, a circumstance may arise where the video display system is activated but wherein the user 104 does not remain within a viewing area 114. For example, a user 104 may turn on the video display system 100 comprising a television system, however, move about to attend other tasks before returning to the viewing area 114 to observe the video display presented by the video display system 100. In such situations, the video display system 100 does not make any further adjustments to the video display parameters as the viewing distance X remains undefined.

If the determination of block 204 is affirmative, the method 200 proceeds to determine a face size in a block 210. As previously described, the solid angle Ω subtended by the face region 112 provides an accurate approximation of the viewing distance X as the angle Ω subtended by the face region 112 is proportional to the linear distance X, assuming a constant face area. Following from the face size determination of block 210, the method 200 includes a block 212 wherein one or more variable display parameters are adjusted at least partially as a function of the viewing distance X as indicated by the perceived face size 112.

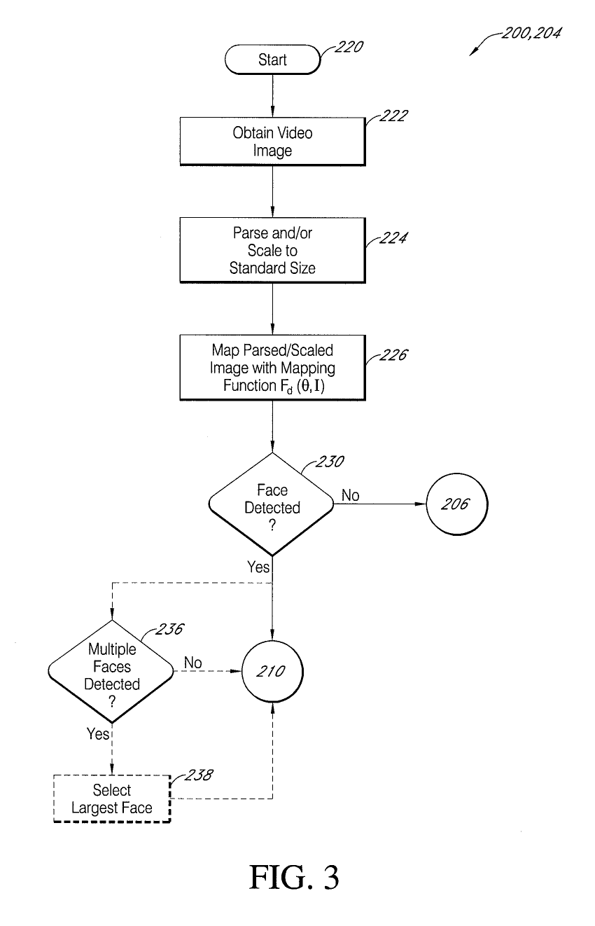

FIG. 3 is a flow chart of one embodiment of block 204 in greater detail. In this embodiment, following from a start block 220, a block 222 follows wherein a video image is obtained, for example, via the sensor 110, of a viewing region facing the display screen 106. Following the block 222 is a block 224 in this embodiment, wherein the video image obtained in block 222 can be partitioned and/or scaled to one or more standard size blocks. For example, in certain embodiments, the video image obtained in block 222 can encompass an area significantly larger than the face region 112 of a user 104. The video image obtained in block 222 can comprise, for example, several tens or hundreds of pixels extending in a two-dimensional orthogonal array that may contain one or more face images and background, non-face images.

Block 224 evaluates the image from block 222 and partitions or scales portions of video image from block 222 having face candidates into corresponding smaller subgroups of the entire video image obtained in block 222. For example, the video image from block 222 can be partitioned into one or more square arrays having smaller size than the video image of block 222. While the face region 112 would generally be expected to be generally round or ovoid in shape, an appropriately sized sub-partition from block 224 having dimensions generally matching that of the face region 112 will result in the face region 112 encompassing a significant portion of the entire sub-partition. Appropriate dimensions of the partition and/or scaling performed in block 224 will be apparent to one of ordinary skill considering the particular dimensions and specifications of a given application. However, in at least certain embodiments, dimensions are preferably in the range from approximately 12×12 pixels to 240×240 pixels. In one exemplary embodiment, the video image obtained in block 222 is partitioned or scaled in block 224 to a plurality of 24×24 standard size sub-partitions corresponding to identified face candidates.

Following from block 224 is a block 226 wherein possible face candidates arranged within the standard size sub-partitions of the video image from block 224 are mapped into a binary value using a mapping function F_{d}(θ, I). In this embodiment, θ is a set of recognition parameters and I comprises the potential face candidate. If the mapping function returns a value of 1, a face has been detected. A positive result of the decision block 230 determining whether or not a face has been detected proceeds to block 210 as previously described whereas a negative result of the decision of block 230 proceeds to block 206 as previously described.

In one embodiment, the method 200 includes offline training to improve the detection accuracy of the method 200 in accurately identifying face regions 112 existing in the field of view of the sensor 110 and to reduce false positives. In this embodiment, a number of face region 112 images are presented fᵢ, 1≦i≦n_{f}. A number of non-face images are also presented nⱼ, 1≦j≦nₙ, where n_{f} is the number of face samples and nₙ is the number of non-face samples. The characteristics of the mapping parameters θ are adjusted to reduce detection errors/increase detection accuracy in one embodiment according to

$$\hat{Θ} = {arg}_{Θ} min ( {\sum }_{j = 1}^{{N}_{n}} {F}_{d} ( Θ , {I}_{j} ) - {\sum }_{i = 1}^{{N}_{f}} {F}_{d} ( Θ , {I}_{i} ) )$$

In one embodiment, the mapping parameters θ can be obtained via an iterative training process. An initial set of mapping parameters θ be evaluated and adjusted for improved mapping accuracy. In at least certain embodiments, training of face detection algorithms is performed offline, e.g. prior to purchase and use of the system by an end user. It will also be understood that this is simply exemplary of one of many possible embodiments of a face detection algorithm and that a variety of face detection algorithms will be well known to one of ordinary skill and can be implemented without detracting from the scope of the invention.

It will also be understood that in certain implementations, multiple users or viewers 104 may be present within a viewing region of the video display 106. Thus, in certain embodiments, the method 200 includes a block 236 wherein a determination is made whether multiple faces have been detected within the viewing field. If the result of decision block 236 is negative, e.g., that only a single face region 112 exists in the viewing field of the video display 106, the method proceeds directly to block 210 as previously described. If the result of decision block 236 is affirmative, e.g., that multiple face regions 112 corresponding to multiple viewers/users 104 are present in the viewing field, a block 238 proceeds wherein the largest face region 112 is selected. The method 200 then proceeds to block 210 with the selected largest face region 112 used as the basis for any adjustments in the adjustable video display parameters.

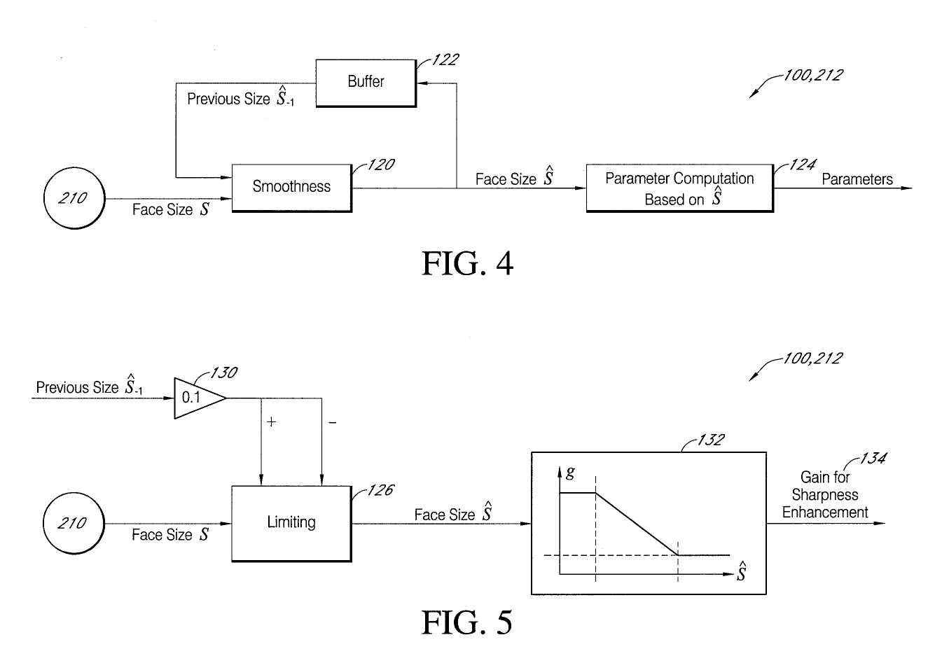

FIGS. 4, 5, and 6 are functional block diagrams of portions of the video display system 100 adapted to implement embodiments of the adjustment block 212. In certain embodiments, the processes of various embodiments as illustrated by FIGS. 4, 5, and 6 can be implemented at least in part, by one or more processors of the display system 100. In certain embodiments, the video display system 100 and method 200 implement changes in the variable video display parameters in a smoothed or buffered manner. For example, in certain implementations, it is preferred that any changes in the perceived qualities of the video images presented on the display screen 106 be performed in a gradual manner to avoid disruption in the user's viewing experience.

In one embodiment, as illustrated in FIG. 4, a current face size for example, as obtained in block 210, is provided to a smoothness assurance module 120 along with a previous face size Ŝ-1 for example from a buffer 122. The buffer 122 is configured to store a previously determined smoothed face size Ŝ₁ previously calculated. The smoothness assurance module 120 acts on the current face size Ŝ data and previous smooth face size data Ŝ₁ to generate a smoothed current face size signal Ŝ. The smoothed face size signal Ŝ is provided to a parameter computation module 124 to provide any revised video display parameter controls indicated by possible differences between the smooth face size signal Ŝ and the previous smooth face size Ŝ₋₁. It will be understood that in certain implementations, the system 100 and method 200 can result in relatively small to no changes in the video display parameters between subsequent viewing sessions. For example, if a single user 104 repeatedly sits at the same location, e.g., at substantially the same viewing distance X from the video display screen 106, the viewing situations are in this regard substantially similar and would not indicate significant changes in the video display parameters. If, however, the viewing situation changes between subsequent viewing sessions, the system and method 100, 200 facilitate automatic adjustment of one or more video display parameters without requiring direct interaction of the user 104 and in a manner that avoids disconcerting rapid change in the perceived quality of images portrayed on the display screen 106.

FIG. 5 illustrates a further functional block diagram of embodiments of the system 100 and method block 212 wherein a current determined face size Ŝ, for example, as obtained in block 210 is provided to a limiting module 126. A previous smoothed or buffered face size Ŝ₋₁ is provided to a change limiting module 130. For example, in one embodiment, change in the smoothed face size Ŝ is limited to no more than ±10% of a previous smoothed face size Ŝ-₁. Thus, in one embodiment, the change limiting module 130 provides upper and lower bounds as inputs to the limiting module 126 setting limits on the deviation between the smooth face size Ŝ and the previously smoothed face size Ŝ₋₁. Again, it is generally preferred that any changes in the video display parameters, for example, any changes based at least partially on viewer face size as indicative of viewing distance X be relatively gradual and smooth in nature to avoid disruptions in the user's viewing experience.

In this embodiment, the smoothed face size Ŝ is provided as one variable to a parameter relation module 132. In one embodiment, the parameter relation module 132 defines a relationship between gain for sharpness enhancement of the displayed video image as a function of smoothed face size Ŝ. The parameter relation module 132 generates an output 134 defining a gain to be used for one or more video display parameters, such as sharpness based on the measured face size Ŝ as limited by the modules 126 and 130. In certain embodiments, a plurality of display parameters can be adjusted individually. In certain embodiments, smoothness control can be implemented individually for adjustment of the display parameters. For example smoothness control can be implemented under different change limits, depending on the particular display parameter of interest. In certain embodiments, adjustment of multiple display parameters can be performed substantially simultaneously and/or can occur at different times.

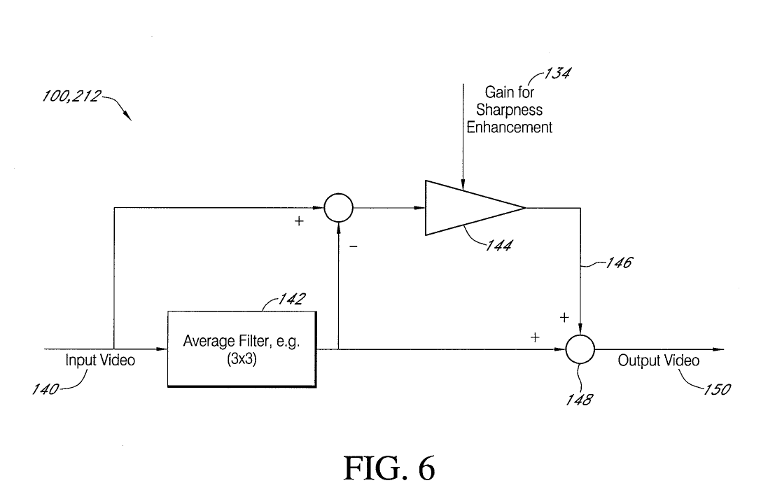

The gain signal 134 can be provided as an input as illustrated in FIG. 6. In this embodiment, an input or raw video signal 140 is provided to an averaging filter, for example, a 3×3 averaging filter 142. The raw or input video signal 140 is also provided as an input together with the output of the average filter 142 to an amplifier 144. The amplifier 144 combines the raw input video signal 140 and the output of the average filter 142 and generates an amplifier output signal 146 as a function of the gain signal 134. Thus, the amplifier output signal 146 is a function not only of the raw input video signal, but also an average filter signal 142 based on previous characteristics of the raw input video signal 140 as well as the gain signal 134 generated as a function of current and previously existing measurements of viewer face size(s). The amplifier output signal 146 is combined with the average filter signal 142 at 148 to generate an output video signal 150.

The output video signal 150 is a combination of the raw input video data 140, temporal averaging filtering from the average filter module 142, and gain adjustments according to the signal 134 generated as a function of viewing distance X. Thus, the output video signal 150 represents a signal which may be modified for improved viewing quality based on a current viewing distance X but also reflective of previous viewing circumstances to avoid disconcerting rapid changes in the video display parameters. The system 100 and method 200 also provide the advantage of generating the revised output video signal 150 without requiring direct action or input on the part of the user 104. This aspect provides improved perceived video quality from the display screen 106 without burdening the user 104 to actuate user controls 102, 102′, or even to be aware of the implementation of adjustments in the video display parameters.

Further embodiments are based at least in part on a realization that existing video enhancement algorithms disregard the viewing time of the viewer. For example, once adjusted, existing display systems provide a constant video quality regardless of how long the viewer may have been viewing the video display. Embodiments are based at least partially on an appreciation that a viewer's visual system will gradually become adapted to existing environmental conditions. In general, a person's visual physical characteristics will change over time and thus the effective perceived impression of the video quality of a display differs over time. For example, it will generally differ for short-term viewing as compared to long-term viewing. Certain embodiments thus implement video display parameter adjustment based at least partially on a determination of the viewer's viewing time or duration.

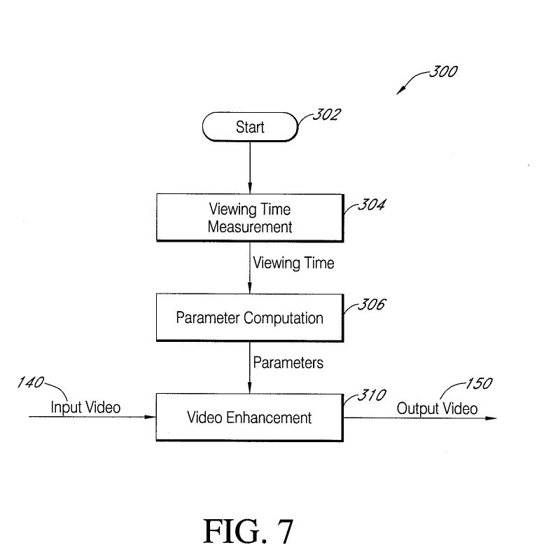

FIG. 7 illustrates one embodiment of a method 300 of adjusting video display parameters as a function of viewing characteristics, with this embodiment including the viewing characteristic of time. In this embodiment, following from a start block 302, a viewing time measurement is performed in a block 304. In one embodiment, the measurement of block 304 proceeds simply as a direct timing measurement with the sensor 110 comprising a timer or clock. It will be understood that the timing measurement of block 304 can be directed to one or more particular measures of doing time. For example, in one embodiment, the viewing time measurement of block 304 is directed to a total time of which the system 100 is activated. Thus, in one embodiment, the viewing time measurement of block 304 need not explicitly determine that a user is actively viewing the video screen 106 but rather is more simply directed to the duration that the system 100 has been active.

In one embodiment, the viewing time measurement of block 304 can be directed to the duration or time that a particular channel or other video input signal has been selected. For example, in one embodiment, the viewing time measurement of block 304 resets if the user selects a different viewing channel or switches between different video sources. Thus, if a user switches from a broadcast television channel to a recorded video source, such as a DVD, the viewing time measurement of block 304 can reset to reflect only the viewing time of the currently active video source in addition to or as an alternative to the total time which the video display system 100 has been active. Events indicating selection of a new television channel or alternate video input source can correspond to activity on one or both of the user input controls 102, 102′. Following from the viewing time measurement of block 304 is a parameter computation block 306. The parameter computation block 306 determines any adjustments in the adjustable video display parameters that may be indicated for the determined viewing time measurement from block 304. It will be understood that in certain embodiments, for certain viewing times as determined in block 304, a given video display parameter may not indicate adjustment whereas for other viewing times, the same adjustable video display parameter may indicate an adjustment.

Following from the parameter computation of block 306, a block 310 follows wherein an input video signal 140 is adjusted or enhanced to provide an output video signal 150 adjusted at least partially as a function of the determined viewing time. It will be understood that the output video signal 150 can also include adjustment for other viewing characteristics besides viewing time, such as the previously described viewing distance parameter adjustments, and/or others.

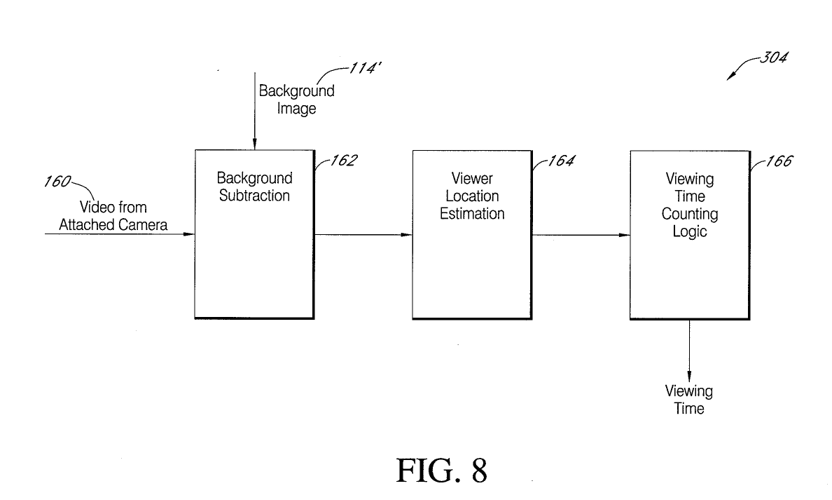

FIG. 8 illustrates a further embodiment of the viewing time measurement block 304 which in this embodiment performs an active measurement of the user/viewer 104. In this embodiment, the sensor 110 comprising a camera obtains multiple images of the viewing scene 114 to determine presence of the viewer 104. More particularly, in one embodiment, the sensor 110 obtains a background image 114′ with no user 104 present in the scene. The system 100 stores this background image 114′ to store representative data of the appearance of the background scene 114′ with no viewer 104 present. Subsequently, the sensor 110 obtains a video image 160 of the viewing scene 114 with a user 104 present. The two images of the background scene 114 without a user 114′ and with a user 160 are provided to a block 162 which performs a background subtraction. The block 162 effectively compares the two image signals 114′ and 160 and evaluates that regions of the two signals sharing high similarity correspond to areas of the viewing scene 114 not corresponding to presence of the user 104. However, regions of the background scene 114 as indicated by the signals 114′ and 160 exhibiting relatively high differences indicate presence of one or more users 104 in the viewing scene 114.

Thus, following from the background subtraction of block 162, a viewer location block 164 returns a value whether or not a user 104 is observed in the viewing scene 114. If the two signals 114′ and 160 exhibit substantial similarity, the viewer location block 164 returns a negative value indicating that a user is not present and that a current viewing time is effectively null. If, however, the viewer location block 164 identifies one or more relatively high difference areas in the data of images 114′ and 160, a signal is provided to a viewing time counting logic block 166 to initiate the viewing time measurement. This embodiment provides the advantage of actively monitoring for presence of a user 104 within the viewing region 114′. Thus, for example, in circumstances where a user may activate the video display system 100 but relatively rapidly leave the viewing area, adjustments would be suppressed in the variable video display parameters even though the video display parameter may be active for some period of time.

Similarly, this embodiment provides the advantage of accommodating entry and exit of the user 104 in the viewing scene 114. Thus, in circumstances where a user may activate the video display system 100 and view images for some portion of time, leave the viewing region 114, and subsequently return to the viewing scene 114, the system 100 is adapted to accommodate for such interruptions in the user's 104 viewing circumstance. Thus, rather than evaluating the user's viewing situation as an extended single viewing session and adjusting the adjustable video display parameters accordingly, the system 100 is adapted to correctly instead identify a sequence of intermittent shorter viewing periods and adjust the video display parameters based on separate shorter viewing intervals rather than a single longer viewing interval.

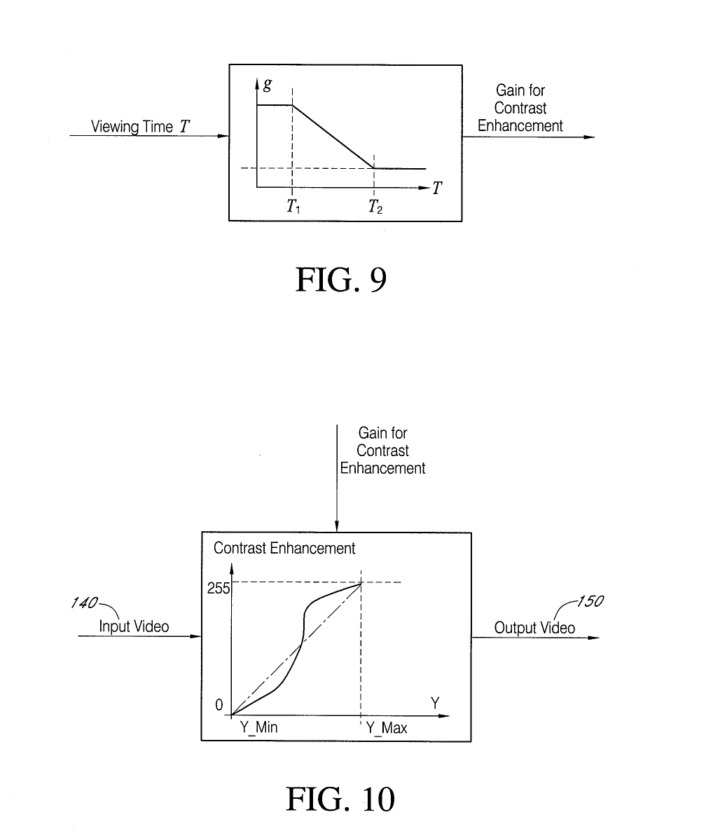

FIG. 9 illustrates one embodiment between measured viewing time T and a video display parameter, in this embodiment comprising gain for contrast enhancement. In this embodiment, the gain for contrast enhancement G holds substantially constant for relatively short durations of viewing time T₁. For more extended periods of viewing time T₂, the gain G ramps down to a lower substantially constant value and remaining substantially constant for more extended viewing times>T₂.

FIG. 10 illustrates a further embodiment of adjustment of one or more video display parameters to provide a modified output video signal 150. In this embodiment, the raw or input video signal 140 is subject to contrast enhancement as a function of the gain for contrast enhancement signal, for example, as determined by the embodiment illustrated in FIG. 9. In one embodiment, the contrast enhancement can proceed in a substantially proportional or linear manner. In another embodiment, the contrast enhancement can proceed along a curvilinear relationship.

As previously noted, the adjustable video display parameters can comprise multiple characteristics of the displayed video image. The various systems and methods of embodiments of the invention can be automatically implemented, at least in part, by one or more processors of the display system 100. For example, the factors influencing display parameter adjustment can comprise the previously described characteristics of viewing distance and viewing time as well as other characteristics that may indicate adjustment in the adjustable video display parameters. Also as previously noted, the adjustable video display parameters can include but are not limited to brightness, contrast, color, tint, sharpness, analog noise reduction, MPEG noise reduction, contrast enhancement, sharpness enhancement, etc.

Although the above disclosed embodiments of the present teachings have shown, described and pointed out the fundamental novel features of the invention as applied to the above-disclosed embodiments, it should be understood that various omissions, substitutions, and changes in the form of the detail of the devices, systems and/or methods illustrated may be made by those skilled in the art without departing from the scope of the present teachings. Consequently, the scope of the invention should not be limited to the foregoing description but should be defined by the appended claims.

What is claimed is:

1. A video display comprising:
a display screen adapted to display video images according to adjustable display parameters;
at least one viewer sensor configured to determine at least one variable viewer characteristic; and
a display controller in communication with the at least one viewer sensor and wherein the controller is adapted to adjust the display parameters to adjust the displayed video image quality at least partially as a function of the variable viewer characteristic.

2. The video display of claim 1, wherein the at least one viewer sensor comprises a time sensor and wherein the variable viewer characteristic comprises viewing time as measured by the time sensor.

3. The video display of claim 2, wherein the viewing time resets when a viewer selects a new video source.

4. The video display of claim 2, wherein the viewing time resets when a viewer interrupts and restarts their viewing.

5. The video display of claim 1, wherein the at least one viewer sensor comprises a camera.

6. The video display of claim 5, wherein the camera is adapted to obtain an image of a field facing the video display and wherein the video display is further adapted to evaluate the image obtained by the camera and to determine whether a viewer face exists in the image and to determine a viewing distance based at least partially on an identified viewer face and wherein the variable viewer characteristic comprise the determined viewing distance.

7. The video display of claim 6, wherein the viewing distance is determined at least partially as an area of the viewer face image.

8. The video display of claim 6, wherein the video display is further adapted to determine a time that a viewer face exists within the field and to adjust the display parameters at least partly as a function of a duration the viewer face has existed within the field.

9. The video display of claim 6, wherein the image is processed to one or more standard size sub-images and compared with a mapping function to determine whether or not a viewer face exists in the field.

10. The video display of claim 6, wherein the system obtains and stores an image of the field with no viewer present and compares subsequent images with the stored no viewer image to determine whether a viewer face exists in the subsequent image.

11. The video display of claim 1, wherein adjustments in the display parameters are limited to within a determined threshold of previously existing values of the display parameters.

12. The video display of claim 1, wherein the display parameters comprise one or more of brightness, contrast, sharpness, and gain.

13. The video display of claim 1, wherein at least one adjustable display parameter is maintained substantially constant for at least some ranges of the viewer characteristic.

14. The video display of claim 1, wherein at least one adjustable display parameter is adjusted in a substantially linear manner for at least some ranges of the viewer characteristic.

15. The video display of claim 1, wherein at least one adjustable display parameter is adjusted in a non-linear manner for at least some ranges of the viewer characteristic.

16. A method of adjusting displayed image quality of a video display system, wherein the video display system operates under an adjustable set of display parameters, the method comprising:
obtaining signals indicative of one or more viewing characteristics of a viewer while video data is being displayed to the viewer;
determining a revised set of display parameters based upon the obtained viewing characteristics so that the display of the video data is improved for the obtained viewing characteristics of the viewer; and
inducing the video display system to adjust the display parameters to the revised set of display parameters.

17. The method of claim 16, wherein the signals indicative of the viewing characteristics of the viewer are sensed passively.

18. The method of claim 16, wherein the signals indicative of the viewing characteristics comprise the duration in which the video data is viewed.

19. The method of claim 18, wherein the duration is determined based upon duration from the time in which the viewer last activated a user control.

20. The method of claim 16, wherein the signals indicative of the viewing characteristics are obtained via sensing a distance parameter indicative of the distance the viewer is located from the video display system.

21. The method of claim 20, wherein determining the distance parameter comprises sensing the viewer's face and using the sensed viewer's face to determine the distance parameter.

22. The method of claim 21, wherein sensing the viewer's face comprises obtaining an image of the user's face and transforming that image into a plurality of standard format sub-images.

23. The method of claim 22, wherein the standard format sub-images are used to determine a size parameter of the user's face and wherein the size parameter of the user's face is used to determine the distance parameter.

24. The method of claim 16, wherein inducing the video display system to adjust the display parameters comprises adjusting one or more of brightness, contrast, sharpness, and gain.

25. A video display system for displaying video images to at least one viewer according to an adjustable set of viewing parameters, the system comprising:
a display screen upon which the video content is displayed;
a sensing component that monitors a viewing parameter indicative of one or more conditions of the viewer's observation of the video images being displayed on the display screen; and
a processor that controls the display and wherein the processor adjusts the adjustable set of viewing parameters based upon the viewing parameter so as to correlate the display parameters to the viewing parameter.

26. The system of claim 25, wherein the sensing component comprises a timer associated with the processor and wherein the viewing parameters are adjusted at least partially as a function of viewing time.

27. The system of claim 26, wherein the timer resets each time the viewer interrupts and restarts their viewing or selects a new video source.

28. The system of claim 25, wherein the sensing component comprises a camera that senses whether the viewer is positioned in a viewing area associated with the video display system.

29. The system of claim 28, wherein the camera is adapted to obtain an image of a field facing the video display and wherein the video display is further adapted to evaluate the image obtained by the camera and to determine whether a viewer face exists in the image and to determine a viewing distance parameter based at least partially on an identified viewer face and wherein the display parameters are adjusted at least partially as a function of the viewing distance.

30. The system of claim 29, wherein the viewing distance parameter is determined at least partially as an area of the viewer face image.

31. The system of claim 29, wherein the video display is further adapted to determine a time that a viewer face exists within the field and to adjust the display parameters at least partially as a function of a duration that the viewer face has existed within the field.

32. The system of claim 25, wherein adjustments in the display parameters are limited to within a determined threshold of previously existing values of the display parameters.

33. The system of claim 25 wherein the display parameters comprise brightness, contrast, and sharpness.

34. A control system for a video display wherein the control system is adapted to communicate with one or more viewer sensors associated with the video display and to obtain signals indicative of one or more characteristics of a viewer viewing the video display and wherein the control system is further adapted to generate control signals and communicate the control signals to the video display to induce adjustment of one or more display parameters under which the video display displays video data.

35. The control system of claim 34, wherein the control system comprises recordable storage media provided with operating instructions adapted to induce a processor to generate the control signals and communicate the control signals to the video display to induce the video display to vary one or more display parameters under which the video display displays video data.

36. The control system of claim 34, wherein the control system comprises electronic circuit components adapted to generate the control signals and communicate the control signals to the video display to induce the video display to vary one or more display parameters under which the video display displays video data.
